(19) United States
(12) Patent Application Publication
(10) Pub. No.: US 2025/0058699 A1
(43) Pub. Date: Feb. 20, 2025

(54) LIGHTING CONTROL DEVICE AND LIGHTING CONTROL METHOD

(71) Applicant: Mitsubishi Electric Corporation, Tokyo (JP)

(72) Inventors: Akifumi YAMAMOTO, Tokyo (JP); Yuki SUMIYOSHI, Tokyo (JP)

(73) Assignee: Mitsubishi Electric Corporation, Tokyo (JP)

(21) Appl. No.: 18/705,640

(22) PCT Filed: Jan. 7, 2022
(86) PCT No.: PCT/JP2022/000302

§ 371 Date: Apr. 29, 2024

(51) Int. Cl. B60Q 1/14; G06V 20/56; G06V 20/58

(52) U.S. Cl. CPC B60Q 1/143; B60Q 2300/054; B60Q 2300/112; B60Q 2300/114; B60Q 2300/41; G06V 20/58; G06V 20/588

(57) ABSTRACT

When it is determined on the basis of a captured image that a preceding vehicle is present, among a plurality of light that irradiates a target region in a plurality of divided regions ahead of a vehicle with light, a light source whose target region is a region where the preceding vehicle is present is controlled in such a manner as to block or attenuate light to the target region. A light source whose target region is a region where the obstacle is estimated to be present is controlled in such a manner as to irradiate the target region with light even when the preceding vehicle is present in the target region.

### TECHNICAL FIELD

The present disclosure relates to a lighting control device and a lighting control method.

### BACKGROUND ART

In general, there is known a technique called an adaptive driving beam (ADB) that blocks light to a region where a preceding vehicle is present in such a manner that an occupant of another vehicle (hereinafter, referred to as a “preceding vehicle”) traveling ahead of a vehicle is not dazzled by changing a light distribution of a high beam of the vehicle.

Conventionally, there is known a lighting control technique that performs light blocking, light attenuation, or normal irradiation for each of a plurality of regions that can be irradiated with a high beam by adjusting light quantities of a plurality of light sources constituting a high beam unit using a so-called ADB technique as described above (for example, Patent Literature 1). In the conventional lighting control technique, among the plurality of regions that can be irradiated with a high beam, light to a region where a preceding vehicle is present is blocked or attenuated, and a region other than the region where the preceding vehicle is present is normally irradiated with a high beam.

### CITATION LIST

### Patent Literature

Patent Literature 1: JP 2009-220649 A

### SUMMARY OF INVENTION

### Technical Problem

For example, when a driver visually recognizes an obstacle ahead of a host vehicle, the driver performs a vehicle operation in such a manner that the vehicle avoids the obstacle by moving across a lane (the lane is a so-called mark line dividing a lane) or in a traveling lane (the lane is a so-called lane). As a result, the vehicle takes a motion that is not assumed to be taken when normally traveling along a road. That is, in a case where the vehicle has taken a motion that is not assumed to be taken when normally traveling along the road, it can be estimated that an obstacle is present in the lane in which the vehicle is traveling.

Thus, in a case where a preceding vehicle has taken a motion that is not assumed to be taken when normally traveling along a road, it can be estimated that an obstacle is present, but in a conventional technique, this is not considered. Therefore, in the conventional technique, there is a problem that, in a case where light to a region where a preceding vehicle is present is blocked or attenuated, even when the preceding vehicle moves across a lane or in a traveling lane in order to avoid an obstacle ahead of the preceding vehicle, if the movement is performed in a region light to which is blocked or attenuated, control to block or attenuate light to the region is continuously performed. As a result, there is a possibility that an occupant of the vehicle is delayed in visually recognizing the obstacle that hinders traveling of the vehicle.

The present disclosure has been made in order to solve the above problems, and an object of the present disclosure is to provide a lighting control device capable of irradiating a region where an obstacle is estimated to be present with light in a case where control to block or attenuate light to a region where a preceding vehicle is present is performed.

### Solution to Problem

A lighting control device according to the present disclosure includes: a captured image acquiring unit that acquires a captured image that captures an image ahead of a vehicle; a preceding vehicle presence or absence determining unit that determines, on the basis of the captured image acquired by the captured image acquiring unit, whether or not a preceding vehicle traveling ahead of the vehicle is present in a traveling lane in which the vehicle is traveling; a preceding vehicle information detecting unit that detects information regarding movement of the preceding vehicle in a case where the preceding vehicle presence or absence determining unit determines that the preceding vehicle is present; an obstacle presence or absence estimating unit that estimates, on the basis of the information regarding movement of the preceding vehicle detected by the preceding vehicle information detecting unit, whether or not an obstacle is present in the traveling lane; and a lighting control unit that controls, when the preceding vehicle presence or absence determining unit determines that the preceding vehicle is present, a light source whose target region is a region where the preceding vehicle is present among a plurality of light sources arranged in an array that constitutes a high beam unit and irradiates a target region in a plurality of divided regions ahead of the vehicle with light in such a manner as to block or attenuate light to the target region, and to control, in a case where the obstacle presence or absence estimating unit estimates that the obstacle is present in the traveling lane, a light source whose target region is a region where the obstacle is estimated to be present among the plurality of light sources in such a manner as to irradiate the target region with light even when the preceding vehicle is present in the target region.

### Advantageous Effects of Invention

According to the present disclosure, in a case where control to block or attenuate light to a region where a preceding vehicle is present is performed, a region where an obstacle is estimated to be present can be irradiated with light.

### BRIEF DESCRIPTION OF DRAWINGS

FIG. 1 is a diagram illustrating a configuration example of a lighting control device according to a first embodiment.

FIGS. 2A and 2B are diagrams for explaining an example of a high beam irradiation situation controlled by the lighting control device in a case where a preceding vehicle is present and an obstacle is estimated to be present in a traveling lane in the first embodiment.

FIGS. 3A and 3B are diagrams for explaining an example of a high beam irradiation situation controlled by the lighting control device in a case where a preceding vehicle is present and an obstacle is estimated not to be present in a traveling lane in the first embodiment.

FIG. 4 is a flowchart for explaining an example of operation of the lighting control device according to the first embodiment.

FIG. 5 is a flowchart for explaining an example of an obstacle presence or absence estimating process of step ST6 in FIG. 4.

FIG. 6 is a flowchart for explaining an example of a lighting control process of step ST7 in FIG. 4.

FIG. 7 is a flowchart for explaining another example of the obstacle presence or absence estimating process of step ST6 in FIG. 4.

FIG. 8 is a flowchart for explaining another example of the obstacle presence or absence estimating process of step ST6 in FIG. 4.

FIGS. 9A and 9B are each a diagram illustrating an example of a hardware configuration of the lighting control device according to the first embodiment.

### DESCRIPTION OF EMBODIMENTS

Hereinafter, an embodiment of the present disclosure will be described in detail with reference to the drawings.

### First Embodiment

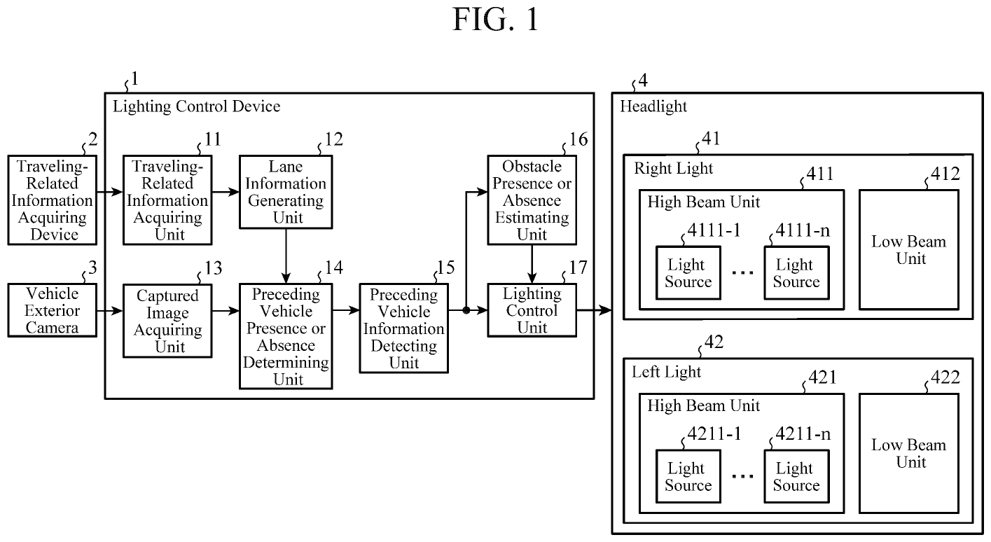

FIG. 1 is a diagram illustrating a configuration example of a lighting control device 1 according to a first embodiment.

In the first embodiment, it is assumed that the lighting control device 1 is mounted on a vehicle (not illustrated).

In a case where another vehicle traveling ahead of the vehicle (hereinafter, referred to as a “preceding vehicle”) is present in a lane in which the vehicle is traveling (the lane is a so-called lane), the lighting control device 1 estimates whether or not an obstacle is present in the lane on the basis of a movement amount or a movement acceleration by which the preceding vehicle has moved, and performs lighting control based on an estimation result of whether or not the obstacle is present. In the following first embodiment, movement of the preceding vehicle refers to movement of the preceding vehicle in a lateral direction with respect to a straight traveling direction of the preceding vehicle. A lane in which the vehicle is traveling is referred to as a “traveling lane”. In the first embodiment, specifically, the lighting control is assumed to be control to cause a plurality of light sources 4111-1 to 4111-n and 4211-1 to 4211-n constituting high beam units 411 and 421 to emit or block light, in other words, a high beam. Details of the control will be described later. In the first embodiment, the “obstacle” includes anything that hinders traveling of a vehicle. Specific examples of the obstacle referred to in the first embodiment include a falling object left on a road surface and damage on the road surface.

The lighting control device 1 is connected to a traveling-related information acquiring device 2, a vehicle exterior camera 3, and a headlight 4. The traveling-related information acquiring device 2, the vehicle exterior camera 3, and the headlight 4 are mounted on a vehicle.

The traveling-related information acquiring device 2 acquires information related to traveling of the vehicle (hereinafter, referred to as “traveling-related information”). In the first embodiment, the traveling-related information acquiring device 2 is assumed to be a car navigation device, a vehicle speed sensor, a vehicle exterior camera that captures an image ahead of the vehicle, or the like. The traveling-related information includes, for example, map information, route guidance information, or a captured image that captures an image ahead of the vehicle (hereinafter, referred to as an “ahead image”). The traveling-related information may include, for example, host vehicle information. The host vehicle information includes, for example, information regarding the position or speed of the vehicle.

The vehicle exterior camera 3 captures an image ahead of the vehicle. In the first embodiment, the vehicle exterior camera 3 is assumed to be a visible light camera.

Note that in a case where the traveling-related information acquiring device 2 is a vehicle exterior camera, the vehicle exterior camera 3 and the traveling-related information acquiring device 2 may be the same vehicle exterior camera.

The headlight 4 is a lighting fixture that illuminates ahead of the vehicle. Since the headlight 4 is a general headlight capable of emitting a high beam and a low beam, a detailed configuration example thereof is omitted. The headlight 4 includes a right light 41 mounted on a right side with respect to a traveling direction of the vehicle in the vehicle and a left light 42 mounted on a left side with respect to the traveling direction of the vehicle in the vehicle. The right light 41 includes a high beam unit 411 that illuminates far and a low beam unit 412 that illuminates near. The left light 42 includes a high beam unit 421 that illuminates far and a low beam unit 422 that illuminates near. The high beam units 411 and 421 include light sources 4111-1 to 4111-n and 4211-1 to 4211-n such as a plurality of LED light sources arranged in an array, respectively, and the light sources 4111-1 to 4111-n and 4211-1 to 4211-n can be individually turned on. In the first embodiment, the arrangement in an array means that the light sources 4111-1 to 4111-n and 4211-1 to 4211-n are arranged in a line in a width direction of the vehicle. By the light sources 4111-1 to 4111-n and 4211-1 to 4211-n being turned on, a region ahead of the vehicle is irradiated with a high beam. In the first embodiment, a region that can be irradiated with a high beam by the high beam units 411 and 421 ahead of the vehicle is referred to as a “high beam irradiation possible region”. It is determined in advance how far ahead of the vehicle and in what range the high beam irradiation possible region is depending on specifications of the high beam units 411 and 421 and the like. The high beam irradiation possible region is divided into a plurality of regions, and it is also determined in advance which region among the plurality of divided regions is set to a region to be irradiated with a high beam (hereinafter, referred to as a “target region”) by each of the light sources 4111-1 to 4111-n and 4211-1 to 4211-n. Note that the positions and sizes of the plurality of divided regions can be set to positions and sizes according to needs, but the positions and sizes are also determined in advance.

The lighting control device 1 according to the first embodiment performs control to emit or block a high beam by turning on or off each of the light sources 4111-1 to 4111-n and 4211-1 to 4211-n.

When receiving a high beam irradiation instruction (details of which will be described later), the lighting control device 1 basically controls the light sources 4111-1 to 4111-n and 4211-1 to 4211-n in such a manner as to irradiate the entire high beam irradiation possible region with a high beam. Note that in a case where a preceding vehicle is present, the lighting control device 1 controls any of the light sources 4111-1 to 4111-n and 4211-1 to 4211-n whose target region is a region including the preceding vehicle in such a manner as to block light to the region including the preceding vehicle. Furthermore, in a case where the preceding vehicle has taken a motion that is not assumed to be taken when normally traveling along the road, the lighting control device 1 estimates that the preceding vehicle has avoided an obstacle. That is, in this case, it is estimated that an obstacle is present in a traveling lane. In the first embodiment, the lighting control device 1 determines, from a movement amount and a movement acceleration by which the preceding vehicle has moved, whether or not the preceding vehicle has taken a motion that is not assumed to be taken when normally traveling along the road. Then, in a case where the lighting control device 1 estimates that an obstacle is present in the traveling lane, the lighting control device 1 controls any of the light sources 4111-1 to 4111-n and 4211-1 to 4211-n whose target region is a region where the obstacle is estimated to be present in such a manner as to block light to the target region regardless of whether or not the preceding vehicle is present. That is, in a case where the lighting control device 1 estimates that an obstacle is present in the traveling lane, even when the region where the obstacle is estimated to be present is a region light to which has been blocked due to presence of the preceding vehicle and the preceding vehicle is still present in the region, the lighting control device 1 controls any of the light sources 4111-1 to 4111-n and 4211-1 to 4211-n whose target region is the region in such a manner as to block light to the target region.

Note that the lighting control device 1 only needs to be able to estimate whether or not an obstacle is present in the traveling lane, and does not need to estimate the position or size of the obstacle. In the first embodiment, the “region where an obstacle is estimated to be present” refers to a region where the lighting control device 1 deems that an obstacle is present in a case where the lighting control device 1 estimates that the obstacle is present in the traveling lane. Hereinafter, the region where an obstacle is estimated to be present, in other words, a region where the lighting control device 1 deems that an obstacle is present is referred to as a “deemed region”.

Note that the lighting control device 1 can not only turn on and off the light sources 4111-1 to 4111-n and 4211-1 to 4211-n, but also can control the amount of light when the light sources 4111-1 to 4111-n and 4211-1 to 4211-n are turned on.

The lighting control device 1 includes a traveling-related information acquiring unit 11, a lane information generating unit 12, a captured image acquiring unit 13, a preceding vehicle presence or absence determining unit 14, a preceding vehicle information detecting unit 15, an obstacle presence or absence estimating unit 16, and a lighting control unit 17.

The traveling-related information acquiring unit 11 acquires traveling-related information from the traveling-related information acquiring device 2.

The traveling-related information acquiring unit 11 outputs the acquired traveling-related information to the lane information generating unit 12.

The lane information generating unit 12 generates lane information regarding the traveling lane on the basis of the traveling-related information acquired by the traveling-related information acquiring unit 11. For example, the lane information generating unit 12 determines, from map information and route guidance information, the position of the traveling lane, such as the number of lanes on one side and the current number of traveling lane from the right. In addition, for example, the lane information generating unit 12 determines, from the map information and the route guidance information, a road shape of the traveling lane. Then, the lane information generating unit 12 generates lane information including, for example, information regarding the determined position of the traveling lane and information regarding the determined road shape of the traveling lane.

The lane information generating unit 12 outputs the generated lane information to the preceding vehicle presence or absence determining unit 14.

The captured image acquiring unit 13 acquires an ahead image from the vehicle exterior camera 3.

The captured image acquiring unit 13 outputs the acquired ahead image to the preceding vehicle presence or absence determining unit 14.

In addition, the captured image acquiring unit 13 stores the acquired ahead image in a storage unit (not illustrated) in time series. The storage unit may be included in the lighting control device 1, or may be included in a place that can be referred to by the lighting control device 1 outside the lighting control device 1. For example, the ahead image for a preset period of time may be stored in the storage unit, or the ahead image stored in the storage unit may be deleted at a preset timing such as when power of the vehicle is turned off.

The preceding vehicle presence or absence determining unit 14 determines whether or not a preceding vehicle traveling ahead of the vehicle is present in the traveling lane on the basis of the lane information generated by the lane information generating unit 12 and the ahead image acquired by the captured image acquiring unit 13.

The preceding vehicle presence or absence determining unit 14 only needs to determine presence or absence of the preceding vehicle by performing a known image recognizing process on the ahead image. Note that, for example, in a case of a sharp curve, an image of the preceding vehicle is captured in such a manner as to be largely shifted to the right or left on the ahead image. In a case where there is a vehicle whose image is captured with a large shift to the right or left on the ahead image, it may be difficult to determine that the vehicle is the preceding vehicle only from the ahead image. Therefore, the preceding vehicle presence or absence determining unit 14 grasps that the vehicle is traveling on a sharp curve on the basis of the lane information, and determines that the vehicle whose image is captured with a large shift to the right or left on the ahead image is the preceding vehicle by considering that the vehicle is traveling on the sharp curve. Note that the lane information includes information regarding a road shape such as a sharp curve.

The preceding vehicle presence or absence determining unit 14 outputs information indicating whether or not the preceding vehicle is present (hereinafter, referred to as “preceding vehicle presence or absence information”) to the preceding vehicle information detecting unit 15.

In a case where the preceding vehicle presence or absence determining unit 14 determines that the preceding vehicle is present, the preceding vehicle information detecting unit 15 detects information regarding the preceding vehicle (hereinafter, referred to as “preceding vehicle information”). The preceding vehicle information includes, for example, information regarding the position and size of the preceding vehicle and information regarding movement of the preceding vehicle. Specifically, the information regarding movement of the preceding vehicle is information regarding a movement amount of the preceding vehicle and information regarding a movement acceleration of the preceding vehicle. More specifically, the information regarding movement of the preceding vehicle is information regarding a movement amount by which the preceding vehicle has moved in a lateral direction with respect to a straight traveling direction of the preceding vehicle, or information regarding a movement acceleration by which the preceding vehicle has moved in the lateral direction with respect to the straight traveling direction of the preceding vehicle.

For example, the preceding vehicle information detecting unit 15 detects the position and size of the preceding vehicle in the ahead image by performing a known image recognizing process on the ahead image. For example, the preceding vehicle information detecting unit 15 defines the size of a minimum rectangle surrounding the preceding vehicle in the ahead image as the size of the preceding vehicle, and defines a center of the minimum rectangle as the position of the preceding vehicle. The position of the preceding vehicle is represented by, for example, coordinates on the ahead image. The size of the preceding vehicle is represented by, for example, coordinates of points at four corners of the rectangle on the ahead image.

The preceding vehicle information detecting unit 15 detects, for example, a distance from the center of the lane to the position of the preceding vehicle on the ahead image as the movement amount of the preceding vehicle. For example, the preceding vehicle information detecting unit 15 defines, as the movement amount of the preceding vehicle, a horizontal distance from a point indicating the position of the preceding vehicle to a line passing through a center of the lane in a width direction (hereinafter, referred to as a “width direction center line”) on the ahead image. In the first embodiment, the center of the lane in the width direction is not limited to a strict center, but includes a substantial center within a preset allowable range. Note that this is merely an example, and the preceding vehicle information detecting unit 15 only needs to detect a deviation of the position of the preceding vehicle from the width direction center line on the ahead image as the movement amount of the preceding vehicle.

The preceding vehicle information detecting unit 15 detects the movement acceleration of the preceding vehicle, for example, on the basis of a change amount of a distance from a point indicating the position of the preceding vehicle on the ahead image to the width direction center line on the basis of the ahead image in time series. Note that a past ahead image is stored in the storage unit. The preceding vehicle information detecting unit 15 can detect the movement acceleration of the preceding vehicle on the basis of an ahead image obtained by going back a preset period of time. The preceding vehicle information detecting unit 15 defines movement of the preceding vehicle in a direction away from the width direction center line as positive movement, and defines a movement acceleration in the movement as a positive acceleration. Meanwhile, the preceding vehicle information detecting unit 15 defines movement of the preceding vehicle in a direction approaching the width direction center line as negative movement, and defines a movement acceleration in the movement as a negative acceleration.

The preceding vehicle information detecting unit 15 outputs the preceding vehicle information to the obstacle presence or absence estimating unit 16 and the lighting control unit 17.

Note that, in the first embodiment, the preceding vehicle information detecting unit 15 outputs information regarding the detected position and size of the preceding vehicle and the detected movement of the preceding vehicle to the obstacle presence or absence estimating unit 16 and the lighting control unit 17 as the preceding vehicle information, but this is merely an example. At least information regarding the movement of the preceding vehicle only needs to be output to the obstacle presence or absence estimating unit 16, and at least information of the position and size of the preceding vehicle only needs to be output to the lighting control unit 17. For example, the preceding vehicle information detecting unit 15 may output information regarding the movement of the preceding vehicle to the obstacle presence or absence estimating unit 16, and output information regarding the position and size of the preceding vehicle to the lighting control unit 17.

In a case where the preceding vehicle presence or absence determining unit 14 does not determine that the preceding vehicle is present, the preceding vehicle information detecting unit 15 outputs information indicating that it is not determined that the preceding vehicle is present (hereinafter, referred to as “preceding vehicle absent information”) to the obstacle presence or absence estimating unit 16 and the lighting control unit 17.

The obstacle presence or absence estimating unit 16 estimates whether or not an obstacle is present in the traveling lane on the basis of the preceding vehicle information output from the preceding vehicle information detecting unit 15. In the first embodiment, the process of estimating whether or not an obstacle is present in the traveling lane, performed by the obstacle presence or absence estimating unit 16 is referred to as an “obstacle presence or absence estimating process”. Note that, in the first embodiment, the obstacle presence or absence estimating unit 16 only needs to be able to estimate whether or not an obstacle is present in the traveling lane, and does not need to estimate the position or size of the obstacle.

For example, the obstacle presence or absence estimating unit 16 estimates whether or not an obstacle is present in the traveling lane by comparing the movement amount with a preset threshold (hereinafter, referred to as a “movement amount determining threshold”) or comparing the movement acceleration with a preset threshold (hereinafter, referred to as a “movement acceleration determining threshold”). The movement amount determining threshold and the movement acceleration determining threshold are stored in advance in an internal memory of the obstacle presence or absence estimating unit 16 or in a place that can be referred to by the obstacle presence or absence estimating unit 16 outside the obstacle presence or absence estimating unit 16. The obstacle presence or absence estimating unit 16 acquires the stored movement amount determining threshold and movement acceleration determining threshold, and performs the above comparison.

In a case where the movement amount is more than the movement amount determining threshold or in a case where the movement acceleration is more than the movement acceleration determining threshold, the obstacle presence or absence estimating unit 16 estimates that an obstacle is present in the traveling lane. For example, when a driver visually recognizes that there is an obstacle which is likely to collide if the vehicle is traveling straight on a road in front of the vehicle during driving, the driver performs a vehicle operation in such a manner that the vehicle avoids the obstacle by moving across a lane (the lane is a so-called mark line dividing a lane) or in a traveling lane (the lane is a so-called lane) by turning a steering wheel. For example, when avoiding the obstacle, the driver may increase an acceleration in order to quickly avoid the obstacle. Therefore, for example, in a case where the movement amount of the preceding vehicle is more than the movement amount determining threshold or in a case where the movement acceleration is more than the movement acceleration determining threshold on the ahead image, the obstacle presence or absence estimating unit 16 estimates that the preceding vehicle has avoided an obstacle on the traveling lane, that is, the obstacle is present on the traveling lane.

Meanwhile, in a case where the movement amount is equal to or less than the movement amount determining threshold or in a case where the movement acceleration is equal to or less than the movement acceleration determining threshold, the obstacle presence or absence estimating unit 16 estimates that no obstacle is present in the traveling lane.

The obstacle presence or absence estimating unit 16 outputs information indicating whether or not an obstacle has been estimated to be present (hereinafter, referred to as “obstacle estimating information”) to the lighting control unit 17.

When receiving the high beam irradiation instruction, the lighting control unit 17 individually controls the light sources 4111-1 to 4111-n and 4211-1 to 4211-n of the high beam units 411 and 421 in such a manner as to emit or block light, that is, a high beam, to the target region. For example, the vehicle includes a high beam switch. For example, the driver inputs the high beam irradiation instruction by operating the high beam switch during night driving. The lighting control unit 17 receives the irradiation instruction input by the driver.

In the first embodiment, high beam emitting or blocking control performed by the lighting control unit 17 on the light sources 4111-1 to 4111-n and 4211-1 to 4211-n of the high beam units 411 and 421 is referred to as a “lighting control process”. Note that the high beam irradiation control performed by the lighting control unit 17 on the light sources 4111-1 to 4111-n and 4211-1 to 4211-n in the “lighting control process” is assumed to be control to turn on the light sources 4111-1 to 4111-n and 4211-1 to 4211-n with a maximum light amount of the light sources 4111-1 to 4111-n and 4211-1 to 4211-n.

The lighting control process will be described separately for a case where a preceding vehicle is present and a case where no preceding vehicle is present.

<Case where Preceding Vehicle is Present>

In a case where a preceding vehicle is present, the lighting control unit 17 determines whether or not the obstacle presence or absence estimating unit 16 has estimated that an obstacle is present in the traveling lane. Note that in a case where the preceding vehicle information is output from the preceding vehicle information detecting unit 15, the lighting control unit 17 only needs to determine that a preceding vehicle is present.

<Case where Preceding Vehicle is Present and Obstacle is Present>

In a case where a preceding vehicle is present and the obstacle presence or absence estimating unit 16 estimates that an obstacle is present in the traveling lane, the lighting control unit 17 controls any of the light sources 4111-1 to 4111-n and 4211-1 to 4211-n of the high beam units 411 and 421 whose target region is the deemed region in the high beam irradiation possible region in such a manner as to irradiate the target region with a high beam. Specifically, the lighting control unit 17 turns on any of the light sources 4111-1 to 4111-n and 4211-1 to 4211-n whose target region is the deemed region. In the first embodiment, the lighting control unit 17 defines a region corresponding to a front of the vehicle (hereinafter, referred to as a “front region”) as the deemed region. As described above, the obstacle presence or absence estimating unit 16 estimates whether or not an obstacle is present in the traveling lane, but does not estimate the position or size of the obstacle. The lighting control unit 17 defines, as the deemed region, the front region where the current travel of the vehicle is hindered in a case where an obstacle is present in the region, in other words, where an influence on the current travel of the vehicle is large.

That is, in a case where a preceding vehicle is present and the obstacle presence or absence estimating unit 16 estimates that an obstacle is present in the traveling lane, the lighting control unit 17 controls any of the light sources 4111-1 to 4111-n and 4211-1 to 4211-n (hereinafter, referred to as a “front irradiation light source”) of the high beam units 411 and 421 whose target region is the front region in the high beam irradiation possible region in such a manner as to irradiate the front region with a high beam. Specifically, the lighting control unit 17 turns on the front irradiation light source.

At this time, even when a preceding vehicle is present in the front region, the lighting control unit 17 causes the front region to be irradiated with a high beam.

The lighting control unit 17 controls the light sources 4111-1 to 4111-n and 4211-1 to 4211-n of the high beam units 411 and 421 depending on whether or not a preceding vehicle is present in the deemed region, that is, a region other than the front region.

Specifically, in a case where the region other than the front region is a region where a preceding vehicle is present (hereinafter, referred to as a “preceding vehicle present region”), the lighting control unit 17 controls any of the light sources 4111-1 to 4111-n and 4211-1 to 4211-n of the high beam units 411 and 421 whose target region is the preceding vehicle present region (hereinafter, referred to as a “preceding vehicle present region irradiation light source”) in such a manner as to block a high beam to the preceding vehicle present region. Specifically, the lighting control unit 17 turns off the preceding vehicle present region irradiation light source whose target region is the preceding vehicle present region. Meanwhile, in a case where the region other than the front region is a region where no preceding vehicle is present (hereinafter, referred to as a “preceding vehicle absent region”), the lighting control unit 17 controls any of the light sources 4111-1 to 4111-n and 4211-1 to 4211-n of the high beam units 411 and 421 whose target region is the preceding vehicle absent region (hereinafter, referred to as a “preceding vehicle absent region irradiation light source”) in such a manner as to irradiate the preceding vehicle absent region with a high beam. Specifically, the lighting control unit 17 turns on the preceding vehicle absent region irradiation light source whose target region is the preceding vehicle absent region.

The preceding vehicle information output from the preceding vehicle information detecting unit 15 includes information regarding the position and size of the preceding vehicle on the ahead image. In addition, which region among the plurality of divided regions included in the high beam irradiation possible region is defined as the target region of the light sources 4111-1 to 4111-n and 4211-1 to 4211-n of the high beam units 411 and 421 is determined in advance. The positions and sizes of the plurality of divided regions are also determined in advance. Since the installation position and the angle of view of the vehicle exterior camera 3 are known in advance, it is possible to associate a region on the ahead image with the target region of the light sources 4111-1 to 4111-n and 4211-1 to 4211-n.

Therefore, on the basis of the preceding vehicle information output from the preceding vehicle information detecting unit 15, the lighting control unit 17 can specify which one of the light sources 4111-1 to 4111-n and 4211-1 to 4211-n is the front irradiation light source, the preceding vehicle present region irradiation light source, or the preceding vehicle absent region irradiation light source.

<Case where Preceding Vehicle is Present and No Obstacle is Present>

In a case where a preceding vehicle is present and the obstacle presence or absence estimating unit 16 estimates that no obstacle is present in the traveling lane, the lighting control unit 17 controls the light sources 4111-1 to 4111-n and 4211-1 to 4211-n of the high beam units 411 and 421 depending on whether or not a preceding vehicle is present in each of the divided regions in the high beam irradiation possible region. Specifically, in a case where each of the divided regions is the preceding vehicle present region, the lighting control unit 17 controls the preceding vehicle present region irradiation light source whose target region is the preceding vehicle present region in such a manner as to block a high beam to the preceding vehicle present region. Specifically, the lighting control unit 17 turns off the preceding vehicle present region irradiation light source whose target region is the preceding vehicle present region. Meanwhile, in a case where each of the divided regions is the preceding vehicle absent region, the lighting control unit 17 controls the preceding vehicle absent region irradiation light source whose target region is the preceding vehicle absent region in such a manner as to irradiate the preceding vehicle absent region with a high beam. Specifically, the lighting control unit 17 turns on the preceding vehicle absent region irradiation light source whose target region is the preceding vehicle absent region.

<Case where No Preceding Vehicle is Present>

In a case where no preceding vehicle is present, the lighting control unit 17 controls all the light sources 4111-1 to 4111-n and 4211-1 to 4211-n of the high beam units 411 and 421 in such a manner as to irradiate the high beam irradiation possible region with a high beam. Specifically, the lighting control unit 17 turns on all the light sources 4111-1 to 4111-n and 4211-1 to 4211-n.

Note that in a case where the preceding vehicle absent information is output from the preceding vehicle information detecting unit 15, the lighting control unit 17 only needs to determine that no preceding vehicle is present.

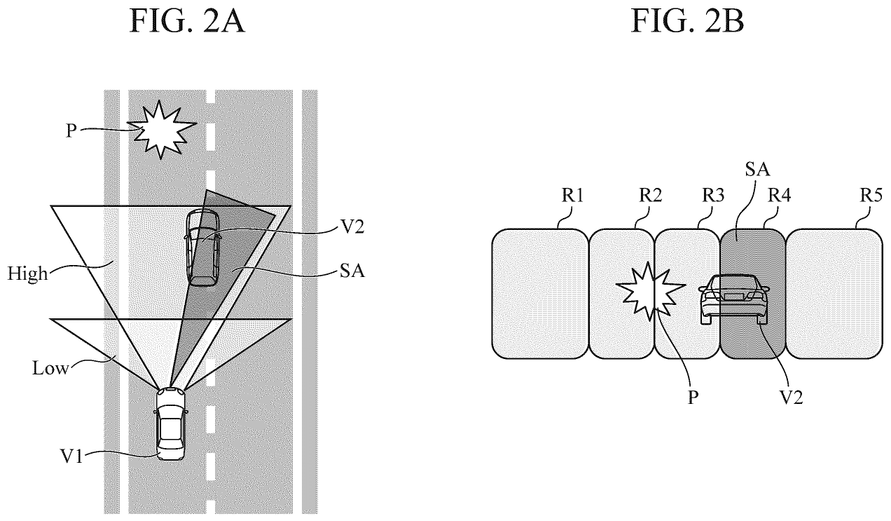

Here, FIGS. 2A and 2B are diagrams for explaining an example of a high beam irradiation situation controlled by the lighting control device 1 in a case where a preceding vehicle is present and an obstacle is estimated to be present in the traveling lane in the first embodiment. FIG. 2A illustrates an overhead view of the traveling lane, and FIG. 2B illustrates a concept of a space ahead of the vehicle irradiated with a high beam as viewed from the vehicle.

In FIGS. 2A and 2B, the vehicle is denoted by “V1”, the preceding vehicle is denoted by “V2”, and the obstacle is denoted by “P”. In FIG. 2B, the high beam irradiation possible region is divided into five regions, and the regions are indicated by “R1”, “R2”, “R3”, “R4”, and “R5” from the left in the drawing. Note that among the regions indicated by R1 to R5, the front region is a region indicated by R3.

In FIG. 2A, the high beam irradiation possible region is indicated by “High”, and a region that can be irradiated with a low beam (hereinafter, referred to as a “low beam irradiation possible region”) is indicated by “Low”. In a case where the lighting control unit 17 receives a low beam irradiation instruction, the lighting control unit 17 causes the low beam units 412 and 422 to irradiate the low beam irradiation possible region with light, that is, a low beam. For example, the vehicle includes a low beam switch. A driver inputs the low beam irradiation instruction by operating the low beam switch. The lighting control unit 17 receives the irradiation instruction input by the driver.

In addition, in FIGS. 2A and 2B, a region light to which is blocked in the high beam irradiation possible region is indicated by “SA”.

FIGS. 2A and 2B illustrate a situation where an obstacle is present in the traveling lane and a preceding vehicle is present between the obstacle and the vehicle, that is, the preceding vehicle is in front of the vehicle and obstructs the obstacle, and the preceding vehicle has taken a motion to avoid the obstacle from the right side of the obstacle, in other words, the preceding vehicle has moved in order to avoid the obstacle from the right side of the obstacle. In a stage before the preceding vehicle takes a motion to avoid the obstacle, the preceding vehicle is present in front of the vehicle, and thus the front region is the preceding vehicle present region. Therefore, in a stage before the preceding vehicle takes a motion to avoid the obstacle, the lighting control unit 17 controls the front irradiation light source in such a manner as to block a high beam. From such a situation, when the preceding vehicle takes a motion to avoid the obstacle, a situation as illustrated in FIGS. 2A and 2B occurs, and the obstacle presence or absence estimating unit 16 estimates that an obstacle is present.

Note that the obstacle is illustrated in FIGS. 2A and 2B, but the position of the obstacle is set to a position for convenience.

In a case where a preceding vehicle is present and an obstacle is estimated to be present in the traveling lane, the lighting control unit 17 controls the front irradiation light source in such a manner as to irradiate the target region, that is, the front region with a high beam. At this time, even when a preceding vehicle is present in the front region, the lighting control unit 17 causes the front region to be irradiated with a high beam. As a result, the front region (a region indicated by R3 in FIG. 2B) is irradiated with a high beam regardless of presence or absence of the preceding vehicle. Until the preceding vehicle takes a motion to avoid the obstacle, in other words, until the preceding vehicle moves, the lighting control unit 17 controls the front irradiation light source in such a manner to block light to the front region. Therefore, the lighting control unit 17 controls any of the light sources 4111-1 to 4111-n and 4211-1 to 4211-n (here, the front irradiation light source) which has blocked light to the target region (here, the front region) in such a manner as to irradiate the target region with light even when the preceding vehicle is present in the target region. The front region is changed from a state in which light to the front region is blocked to a state in which the front region is irradiated with light.

In addition, the lighting control unit 17 also controls the preceding vehicle absent region irradiation light source whose target region is the preceding vehicle absent region other than the front region in such a manner as to irradiate the preceding vehicle absent region with a high beam. As a result, the preceding vehicle absent region (regions indicated by R1, R2, and R5 in FIG. 2B) is also irradiated with a high beam.

Meanwhile, the lighting control unit 17 controls the preceding vehicle present region irradiation light source whose target region is the preceding vehicle present region other than the front region in such a manner as to block a high beam to the preceding vehicle present region. As a result, light to the preceding vehicle present region (a region indicated by R4 in FIG. 2B) is blocked.

In a case where an obstacle is estimated to be present, the lighting control unit 17 performs control to irradiate the front region with a high beam regardless of presence or absence of a preceding vehicle. As a result, in a case where the lighting control device 1 performs control to block or attenuate light to a region where the preceding vehicle is present, the deemed region can be irradiated with light. As a result, the lighting control device 1 can prevent an occupant of the vehicle from being delayed in visually recognizing the obstacle that hinders travel of the vehicle. For example, as in the situation illustrated in FIGS. 2A and 2B, in a case where an obstacle is present ahead of the preceding vehicle, the obstacle is obstructed by the preceding vehicle until the preceding vehicle avoids the obstacle, and the occupant of the vehicle cannot visually recognize the obstacle. In addition, in this case, light to the front of the vehicle is blocked in order to reduce dazzling (so-called glare) given to the preceding vehicle. In such a situation, it is assumed that the preceding vehicle has moved in order to avoid the obstacle. Here, when light to the front of the vehicle is still blocked even if the preceding vehicle moves, it is delayed for the occupant of the vehicle to visually recognize the obstacle. On the other hand, in the lighting control device 1 according to the first embodiment, as described above, an obstacle is estimated to be present due to movement of the preceding vehicle, and the front of the vehicle serving as the deemed region is irradiated with light even when the preceding vehicle is present. As a result, the occupant of the vehicle can ensure visibility of the front of the vehicle and cope with prevention of collision with the obstacle while giving himself or herself plenty of time. The visibility of at least the front of the vehicle is ensured, and the occupant of the vehicle can thereby visually recognize the obstacle and take an action to avoid the obstacle.

In addition, the lighting control device 1 can reduce glare given to the preceding vehicle by performing control to block a high beam to the preceding vehicle present region other than the front region.

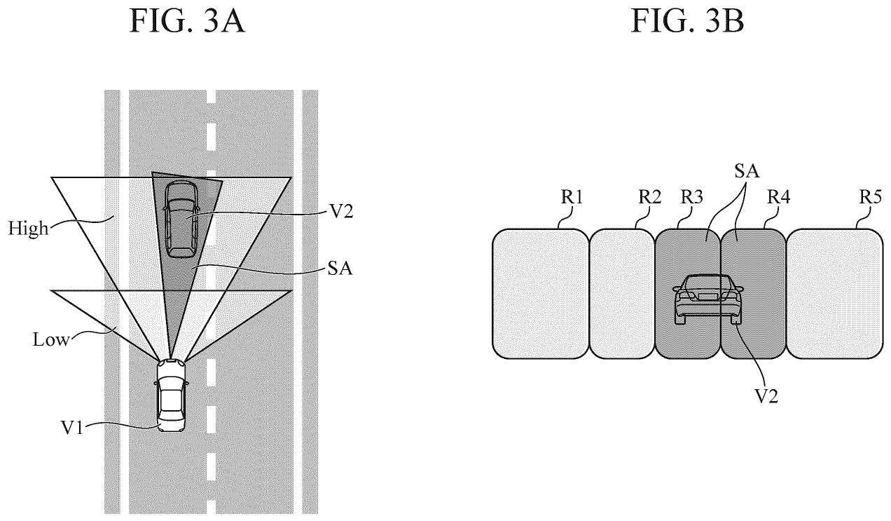

FIGS. 3A and 3B are diagrams for explaining an example of a high beam irradiation situation controlled by the lighting control device 1 in a case where a preceding vehicle is present and an obstacle is estimated not to be present in the traveling lane in the first embodiment. FIG. 3A illustrates an overhead view of the traveling lane, and FIG. 3B illustrates a concept of a space ahead of the vehicle irradiated with a high beam as viewed from the vehicle.

In FIGS. 3A and 3B, the vehicle is denoted by “V1”, and the preceding vehicle is denoted by “V2”. In FIG. 3B, the high beam irradiation possible region is divided into five regions, and the regions are indicated by “R1”, “R2”, “R3”, “R4”, and “R5” from the left in the drawing.

In FIG. 3A, the high beam irradiation possible region is indicated by “High”, and the low beam irradiation possible region is indicated by “Low”.

In addition, in FIGS. 3A and 3B, a region light to which is blocked in the high beam irradiation possible region is indicated by “SA”.

In a case where a preceding vehicle is present and an obstacle is estimated not to be present in the traveling lane, the lighting control unit 17 controls the preceding vehicle present region irradiation light source whose target region is the preceding vehicle present region in such a manner as to block a high beam to the preceding vehicle present region. As a result, light to the preceding vehicle present region (regions indicated by R3 and R4 in FIG. 3B) is blocked.

Meanwhile, the lighting control unit 17 controls the preceding vehicle absent region irradiation light source whose target region is the preceding vehicle absent region in such a manner as to irradiate the preceding vehicle absent region with a high beam. As a result, the preceding vehicle absent region (regions indicated by R1, R2, and R5 in FIG. 3B) is irradiated with a high beam.

The lighting control device 1 can reduce glare given to the preceding vehicle by performing control to block a high beam to the preceding vehicle present region.

An example of operation of the lighting control device 1 according to the first embodiment will be described.

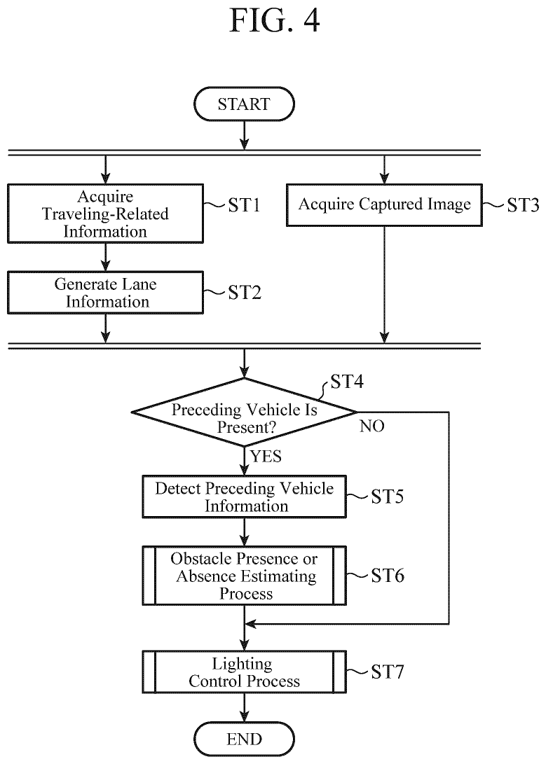

FIG. 4 is a flowchart for explaining an example of operation of the lighting control device 1 according to the first embodiment.

Note that FIG. 4 is a flowchart for explaining an example of operation of the lighting control device 1 in a case where the vehicle is traveling at night and the lighting control device 1 receives a high beam irradiation instruction from an occupant of the vehicle. The lighting control device 1 repeats the operation illustrated in the flowchart of FIG. 4, for example, until receiving a turn-off instruction to turn off the high beam or until power of the vehicle is turned off. Note that the occupant can input a high beam turn-off instruction by operating a high beam switch.

The traveling-related information acquiring unit 11 acquires traveling-related information from the traveling-related information acquiring device 2 (step ST1).

The traveling-related information acquiring unit 11 outputs the acquired traveling-related information to the lane information generating unit 12.

The lane information generating unit 12 generates lane information on the basis of the traveling-related information acquired by the traveling-related information acquiring unit 11 in step ST1 (step ST2).

The lane information generating unit 12 outputs the generated lane information to the preceding vehicle presence or absence determining unit 14.

The captured image acquiring unit 13 acquires an ahead image from the vehicle exterior camera 3 (step ST3).

The captured image acquiring unit 13 outputs the acquired ahead image to the preceding vehicle presence or absence determining unit 14.

The preceding vehicle presence or absence determining unit 14 determines whether or not a preceding vehicle traveling ahead of the vehicle is present in the traveling lane on the basis of the lane information generated by the lane information generating unit 12 in step ST2 and the ahead image acquired by the captured image acquiring unit 13 in step ST3 (step ST4).

The preceding vehicle presence or absence determining unit 14 outputs the preceding vehicle presence or absence information to the preceding vehicle information detecting unit 15.

If the preceding vehicle presence or absence determining unit 14 determines that a preceding vehicle is present in step ST4 (“YES” in step ST4), the preceding vehicle information detecting unit 15 detects preceding vehicle information (step ST5). Specifically, the preceding vehicle information detecting unit 15 detects information regarding the position and size of the preceding vehicle and movement of the preceding vehicle.

The preceding vehicle information detecting unit 15 outputs the preceding vehicle information to the obstacle presence or absence estimating unit 16 and the lighting control unit 17.

In a case where the preceding vehicle presence or absence determining unit 14 does not determine that the preceding vehicle is present, the preceding vehicle information detecting unit 15 outputs preceding vehicle absent information to the obstacle presence or absence estimating unit 16 and the lighting control unit 17.

The obstacle presence or absence estimating unit 16 performs an obstacle presence or absence estimating process on the basis of the preceding vehicle information output from the preceding vehicle information detecting unit 15 in step ST5 (step ST6).

The obstacle presence or absence estimating unit 16 outputs the obstacle estimating information to the lighting control unit 17.

The lighting control unit 17 performs a lighting control process (step ST7).

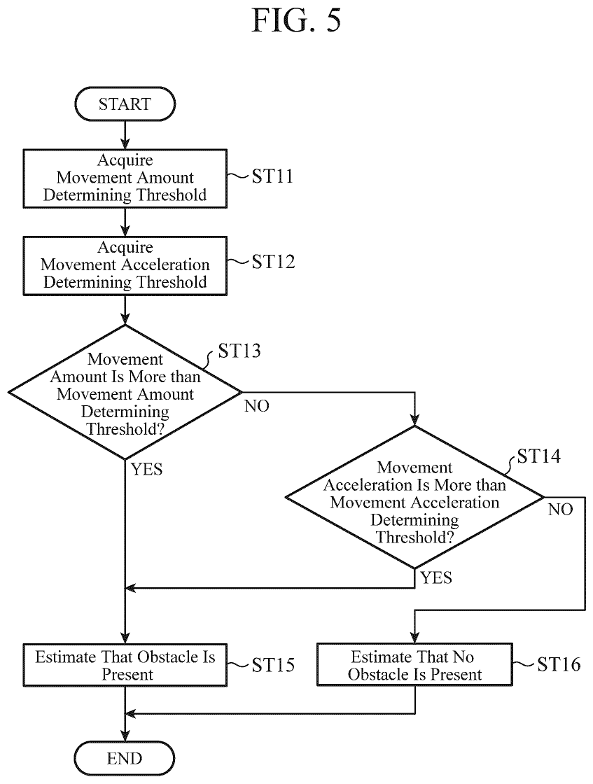

FIG. 5 is a flowchart for explaining an example of the obstacle presence or absence estimating process of step ST6 in FIG. 4.

The obstacle presence or absence estimating unit 16 acquires a movement amount determining threshold stored in advance (step ST11).

The obstacle presence or absence estimating unit 16 acquires a movement acceleration determining threshold stored in advance (step ST12).

The obstacle presence or absence estimating unit 16 determines whether or not a movement amount is more than the movement amount determining threshold (step ST13).

If it is determined in step ST13 that the movement amount is equal to or less than the movement amount determining threshold (“NO” in step ST13), the obstacle presence or absence estimating unit 16 determines whether or not the movement acceleration is more than the movement acceleration determining threshold (step ST14).

If it is determined in step ST13 that the movement amount is more than the movement amount determining threshold (“YES” in step ST13), or if it is determined in step ST14 that the movement acceleration is more than the movement acceleration determining threshold (“YES” in step ST14), the obstacle presence or absence estimating unit 16 estimates that an obstacle is present in the traveling lane (step ST15). Then, the obstacle presence or absence estimating unit 16 outputs the obstacle estimating information to the lighting control unit 17.

If it is determined in step ST14 that the movement acceleration is equal to or less than the movement acceleration determining threshold (“NO” in step ST14), that is, if the movement amount is equal to or less than the movement amount determining threshold and the movement acceleration is equal to or less than the movement acceleration determining threshold, the obstacle presence or absence estimating unit 16 estimates that no obstacle is present in the traveling lane (step ST16). Then, the obstacle presence or absence estimating unit 16 outputs the obstacle estimating information to the lighting control unit 17.

Note that, in the flowchart of FIG. 5, processes are performed in the order of step ST11 and step ST12, but this is merely an example. The order of the process of step ST11 and the process of step ST12 may be reversed. The process of step ST11 only needs to be performed before the process of step ST13 is performed, and the process of step ST12 only needs to be performed before the process of step ST14 is performed.

In addition, in the flowchart of FIG. 5, after determination of step ST13, determination of step ST14 is performed, but this is merely an example. The order of the determination of step ST13 and the determination of step ST14 may be reversed.

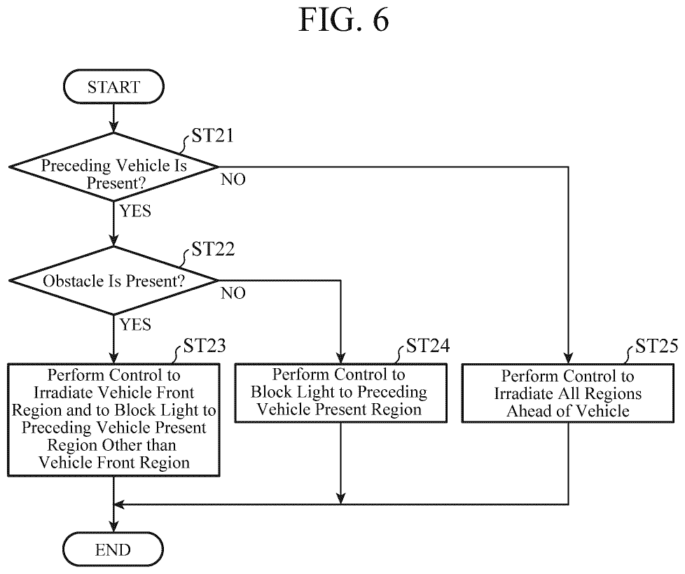

FIG. 6 is a flowchart for explaining an example of the lighting control process of step ST7 in FIG. 4.

The lighting control unit 17 determines whether or not a preceding vehicle is present (step ST21).

If a preceding vehicle is present (“YES” in step ST21), the lighting control unit 17 determines whether or not the obstacle presence or absence estimating unit 16 estimates that an obstacle is present in the traveling lane (step ST22).

If the lighting control unit 17 determines that the obstacle presence or absence estimating unit 16 estimates that an obstacle is present in the traveling lane in step ST22 (“YES” in step ST22), the lighting control unit 17 controls any of the light sources 4111-1 to 4111-n and 4211-1 to 4211-n (here, the front irradiation light source) of the high beam units 411 and 421 whose target region is the deemed region (here, the front region) in the high beam irradiation possible region in such a manner as to irradiate the target region with a high beam. If a region other than the deemed region (here, the front region) is the preceding vehicle present region, the lighting control unit 17 controls the preceding vehicle present region irradiation light source whose target region is the preceding vehicle present region in such a manner as to block a high beam to the preceding vehicle present region (step ST23). If a region other than the deemed region (here, the front region) is the preceding vehicle absent region, the lighting control unit 17 controls the preceding vehicle absent region irradiation light source whose target region is the preceding vehicle absent region in such a manner as to irradiate the preceding vehicle absent region with a high beam.

If the lighting control unit 17 determines that the obstacle presence or absence estimating unit 16 estimates that no obstacle is present in the traveling lane in step ST22 (“NO” in step ST22), in a case where each of the divided regions of the high beam irradiation possible region is a preceding vehicle present region, the lighting control unit 17 controls the preceding vehicle present region irradiation light source whose target region is the preceding vehicle present region in such a manner as to block a high beam to the preceding vehicle present region (step ST24). In addition, in a case where each of the divided regions of the high beam irradiation possible region is the preceding vehicle absent region, the lighting control unit 17 controls the preceding vehicle absent region irradiation light source whose target region is the preceding vehicle absent region in such a manner as to irradiate the preceding vehicle absent region with a high beam.

Meanwhile, if no preceding vehicle is present (“NO” in step ST21), the lighting control unit 17 controls all the light sources 4111-1 to 4111-n and 4211-1 to 4211-n of the high beam units 411 and 421 in such a manner as to irradiate the high beam irradiation possible region with a high beam (step ST25).

As described above, when determining that a preceding vehicle is present on the basis of the lane information and the ahead image, the lighting control device 1 detects information regarding movement of the preceding vehicle, specifically, a movement amount and a movement acceleration, and estimates whether or not an obstacle is present in the traveling lane on the basis of the detected information regarding the movement. Among the plurality of light sources 4111-1 to 4111-n and 4211-1 to 4211-n, the lighting control device 1 controls any of the light sources 4111-1 to 4111-n and 4211-1 to 4211-n whose target region is a region where a preceding vehicle is present in such a manner as to block or attenuate light to the target region. In a case where it is estimated that an obstacle is present in the traveling lane, among the plurality of light sources 4111-1 to 4111-n and 4211-1 to 4211-n, the lighting control device 1 controls any of the light sources 4111-1 to 4111-n and 4211-1 to 4211-n (front irradiation light source) whose target region is the deemed region (front region) in such a manner as to irradiate the target region with light (high beam) even when the preceding vehicle is present in the target region.

As a result, in a case where the lighting control device 1 performs control to block or attenuate light to a region where the preceding vehicle is present, the deemed region can be irradiated with light. As a result, the lighting control device 1 can ensure visibility of an occupant of the vehicle to an obstacle in a situation where the obstacle is estimated to be present in the traveling lane.

For example, even in a situation where the vehicle exterior camera 3 is a visible light camera, and light to a region where an obstacle is present in the traveling lane is blocked or attenuated due to presence of a preceding vehicle, it is possible to detect the obstacle from sensor information by using a sensor such as a millimeter wave sensor. That is, even in a situation where it is difficult to detect an obstacle from the ahead image, it is possible to detect the obstacle using the sensor and to notify an occupant of the vehicle that the obstacle is present. However, in this case, in a case where light is blocked or attenuated due to presence of a preceding vehicle and an obstacle is present in a region light to which is blocked or attenuated, it is necessary to mount a sensor such as a millimeter wave sensor on the vehicle in order to detect the obstacle.

On the other hand, the lighting control device 1 according to the first embodiment can generally estimate that an obstacle is present in the traveling lane on the basis of information from a device originally mounted on the vehicle, such as the traveling-related information acquiring device 2 such as a navigation device or the vehicle exterior camera 3, and can irradiate the deemed region. As a result, it is possible to ensure visibility of an occupant of the vehicle to an obstacle in a situation where the obstacle is estimated to be present in the traveling lane.

In the first embodiment described above, the movement amount determining threshold and the movement acceleration determining threshold are set in advance, but this is merely an example. In the first embodiment described above, the obstacle presence or absence estimating unit 16 may set the movement amount determining threshold and the movement acceleration determining threshold.

For example, the obstacle presence or absence estimating unit 16 may set the movement amount determining threshold and the movement acceleration determining threshold depending on a speed of the vehicle or a distance from the vehicle to a preceding vehicle. The obstacle presence or absence estimating unit 16 only needs to acquire vehicle speed information of the vehicle from, for example, a vehicle speed sensor (not illustrated) mounted on the vehicle. The obstacle presence or absence estimating unit 16 may acquire the vehicle speed information from the traveling-related information acquired via the traveling-related information acquiring unit 11. The traveling-related information includes host vehicle information regarding the speed of the vehicle. In addition, the obstacle presence or absence estimating unit 16 only needs to calculate a distance from the vehicle to the preceding vehicle from the position and size of the preceding vehicle on the ahead image, for example, on the basis of the preceding vehicle information acquired from the preceding vehicle information detecting unit 15.

For example, in a case where the speed of the vehicle is more than a preset threshold (hereinafter, referred to as a “first speed determining threshold”), the obstacle presence or absence estimating unit 16 sets a value less than a preset and stored movement amount determining threshold as a movement amount determining threshold, and replaces the stored movement amount determining threshold with the set movement amount determining threshold. In addition, the obstacle presence or absence estimating unit 16 sets a value less than a preset and stored movement acceleration determining threshold as a movement acceleration determining threshold, and replaces the stored movement acceleration determining threshold with the set movement acceleration determining threshold.

It is determined in advance how much a value less than the stored movement amount determining threshold is set as the movement amount determining threshold, and how much a value less than the stored movement acceleration determining threshold is set as the movement acceleration determining threshold, depending on how much the speed of the vehicle is more than the first speed determining threshold. In addition, for example, the obstacle presence or absence estimating unit 16 may store a table in which a range of the speed of the vehicle, the movement amount determining threshold, and the movement acceleration determining threshold are associated with each other, and may set the movement amount determining threshold and the movement acceleration determining threshold by comparing the table with the speed of the vehicle. The obstacle presence or absence estimating unit 16 only needs to set the movement amount determining threshold and the movement acceleration determining threshold in such a manner that the higher the speed of the vehicle, the less the movement amount determining threshold and the movement acceleration determining threshold. It is assumed that the higher the speed of the vehicle, the higher urgency of operation to avoid an obstacle in a case where the obstacle is present in the traveling lane. The obstacle presence or absence estimating unit 16 sets the movement amount determining threshold and the movement acceleration determining threshold in such a manner that the higher the speed of the vehicle, the less the movement amount determining threshold and the movement acceleration determining threshold, thereby making it easier to estimate that an obstacle is present. As a result, for example, the lighting control device 1 can quickly switch from a situation where light to the front region is blocked due to presence of a preceding vehicle to a situation where the front region is irradiated.

For example, in a case where a distance to the preceding vehicle is less than a preset and stored threshold (hereinafter, referred to as a “distance determining threshold”), the obstacle presence or absence estimating unit 16 sets a value less than the stored movement amount determining threshold as a movement amount determining threshold, and replaces the stored movement amount determining threshold with the set movement amount determining threshold. In addition, the obstacle presence or absence estimating unit 16 sets a value less than the stored movement acceleration determining threshold as a movement acceleration determining threshold, and replaces the stored movement acceleration determining threshold with the set movement acceleration determining threshold.

It is determined in advance how much a value less than the stored movement amount determining threshold is set as the movement amount determining threshold, and how much a value less than the stored movement acceleration determining threshold is set as the movement acceleration determining threshold, depending on how much the distance to the preceding vehicle is less than the distance determining threshold. In addition, for example, the obstacle presence or absence estimating unit 16 may store a table in which a range of the distance to the preceding vehicle, the movement amount determining threshold, and the movement acceleration determining threshold are associated with each other, and may set the movement amount determining threshold and the movement acceleration determining threshold by comparing the table with the distance to the preceding vehicle. The obstacle presence or absence estimating unit 16 only needs to set the movement amount determining threshold and the movement acceleration determining threshold in such a manner that the smaller the distance to the preceding vehicle, the less the movement amount determining threshold and the movement acceleration determining threshold. It is assumed that the smaller the distance to the preceding vehicle, the higher urgency of operation to avoid an obstacle in a case where the obstacle is present in the traveling lane. The obstacle presence or absence estimating unit 16 sets the movement amount determining threshold and the movement acceleration determining threshold in such a manner that the smaller the distance to the preceding vehicle, the less the movement amount determining threshold and the movement acceleration determining threshold, thereby making it easier to estimate that an obstacle is present. As a result, for example, the lighting control device 1 can quickly switch from a situation where light to the front region is blocked due to presence of a preceding vehicle to a situation where the front region is irradiated.

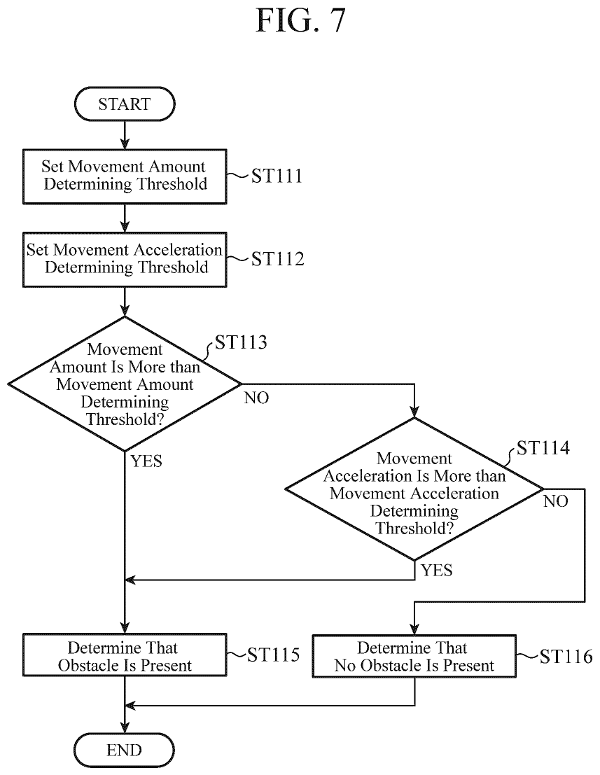

FIG. 7 is a flowchart for explaining another example of the obstacle presence or absence estimating process of step ST6 in FIG. 4, and is a flowchart for explaining details of the obstacle presence or absence estimating process in a case where the obstacle presence or absence estimating unit 16 sets the movement amount determining threshold and the movement acceleration determining threshold.

In a case where the obstacle presence or absence estimating unit 16 sets the movement amount determining threshold and the movement acceleration determining threshold, in step ST6 of FIG. 4, the operation illustrated in the flowchart of FIG. 7 is performed instead of the operation illustrated in the flowchart of FIG. 5. Since specific operations in steps ST113 to ST116 in FIG. 7 are similar to the specific operations in steps ST13 to ST16 in FIG. 5 described above, respectively, redundant description is omitted.

The obstacle presence or absence estimating unit 16 sets a movement amount determining threshold (step ST111).

The obstacle presence or absence estimating unit 16 sets a movement acceleration determining threshold (step ST112).

Note that, in the flowchart of FIG. 7, processes are performed in the order of step ST111 and step ST112, but this is merely an example. The order of the process of step ST111 and the process of step ST112 may be reversed. The process of step ST111 only needs to be performed before the process of step ST113 is performed, and the process of step ST112 only needs to be performed before the process of step ST114 is performed.

In addition, in the flowchart of FIG. 7, after determination of step ST113, determination of step ST114 is performed, but this is merely an example. The order of the determination of step ST113 and the determination of step ST114 may be reversed.

In addition, in the first embodiment described above, the obstacle presence or absence estimating unit 16 may change the movement amount determining threshold and the movement acceleration determining threshold set in advance to be larger in a case where it is determined that a preceding vehicle is about to enter a surrounding facility.

The obstacle presence or absence estimating unit 16 only needs to determine that the preceding vehicle is about to enter a surrounding facility on the basis of, for example, host vehicle information of the vehicle, map information, or an ahead image. The host vehicle information includes information of a vehicle speed and information of a host vehicle position. For example, the obstacle presence or absence estimating unit 16 only needs to acquire the host vehicle information and the map information as traveling-related information from the traveling-related information acquiring device 2 via the traveling-related information acquiring unit 11. In addition, the obstacle presence or absence estimating unit 16 only needs to acquire the ahead image via the captured image acquiring unit 13, the preceding vehicle presence or absence determining unit 14, and the preceding vehicle information detecting unit 15.

For example, the obstacle presence or absence estimating unit 16 performs a known image recognizing process on the ahead image, and determines that the preceding vehicle is about to enter a surrounding facility in a case where the preceding vehicle is turning on a blinker. The obstacle presence or absence estimating unit 16 may determine that the preceding vehicle is about to enter a surrounding facility in a case where the preceding vehicle is turning on a blinker and there is a facility that can be entered around the preceding vehicle. In addition, for example, the obstacle presence or absence estimating unit 16 may determine that the preceding vehicle is about to enter a surrounding facility in a case where the preceding vehicle is turning on a blinker and the speed of the host vehicle is less than a preset threshold (hereinafter, referred to as a “second speed determining threshold”).

The obstacle presence or absence estimating unit 16 only needs to set the movement amount determining threshold and the movement acceleration determining threshold in such a manner that the movement amount determining threshold and the movement acceleration determining threshold increase in a case where it is estimated that the preceding vehicle is about to enter a surrounding facility. In a case where the preceding vehicle enters a surrounding facility, the position of the preceding vehicle moves in a direction away from a center of the lane on the ahead image. The movement is not for avoiding an obstacle. The obstacle presence or absence estimating unit 16 sets the movement amount determining threshold and the movement acceleration determining threshold in such a manner that the movement amount determining threshold and the movement acceleration determining threshold increase in a case where it is estimated that the preceding vehicle is about to enter a surrounding facility, thereby making it difficult to estimate that an obstacle is present. As a result, for example, in a situation where there is no possibility that the vehicle collides with an obstacle, the lighting control device 1 prevents glare from being given to the preceding vehicle by switching from a situation where light to the front region is blocked by presence of the preceding vehicle to a situation where the front region is irradiated.

Note that when it is not determined that the preceding vehicle is about to enter a surrounding facility, the obstacle presence or absence estimating unit 16 returns the movement amount determining threshold and the movement acceleration determining threshold to the values before the change.

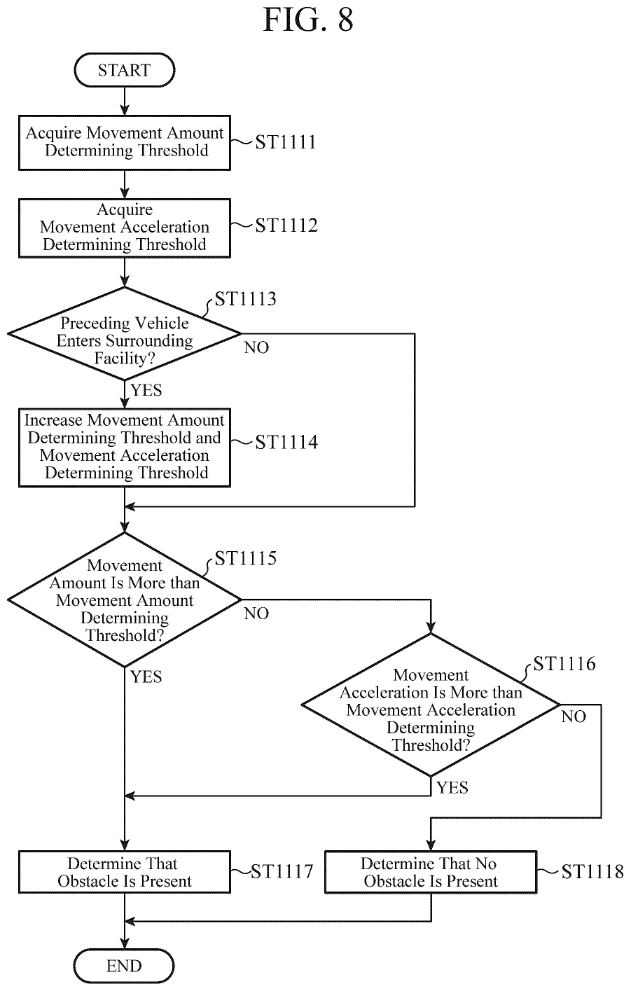

FIG. 8 is a flowchart for explaining another example of the obstacle presence or absence estimating process of step ST6 in FIG. 4, and is a flowchart for explaining details of the obstacle presence or absence estimating process in a case where the obstacle presence or absence estimating unit 16 changes the movement amount determining threshold and the movement acceleration determining threshold when determining that the preceding vehicle is about to enter a surrounding facility.

In a case where the obstacle presence or absence estimating unit 16 changes the movement amount determining threshold and the movement acceleration determining threshold when determining that the preceding vehicle is about to enter a surrounding facility, in step ST6 of FIG. 4, the operation illustrated in the flowchart of FIG. 8 is performed instead of the operation illustrated in the flowchart of FIG. 5. Since specific operations in steps ST1111 and ST1112 and steps ST1115 to ST1118 in FIG. 8 are similar to the specific operations in steps ST11 to ST16 in FIG. 5 described above, respectively, redundant description is omitted.

The obstacle presence or absence estimating unit 16 determines whether or not the preceding vehicle is about to enter a surrounding facility (step ST1113).

If it is determined in step ST1113 that the preceding vehicle is about to enter a surrounding facility (“YES” in step ST1113), the obstacle presence or absence estimating unit 16 changes the movement amount determining threshold and the movement acceleration determining threshold that are set in advance, in other words, the movement amount determining threshold acquired in step ST1111 and the movement acceleration determining threshold acquired in step ST1112 to be larger (step ST1114).

Note that, in the flowchart of FIG. 8, processes are performed in the order of step ST1111 and step ST1112, but this is merely an example. The order of the process of step ST1111 and the process of step ST1112 may be reversed. The process of step ST1111 only needs to be performed before the process of step ST1113 is performed, and the process of step ST1112 only needs to be performed before the process of step ST1114 is performed.

In addition, in the flowchart of FIG. 8, after determination of step ST1115, determination of step ST1116 is performed, but this is merely an example. The order of the determination of step ST1115 and the determination of step ST1116 may be reversed.

In addition, in the flowchart of FIG. 8, instead of the processes of steps ST1111 and ST1112, processes of steps ST111 and ST1112 in FIG. 7 may be performed, respectively. That is, for example, after setting the movement amount determining threshold and the movement acceleration determining threshold depending on a speed of the vehicle or a distance from the vehicle to the preceding vehicle, the obstacle presence or absence estimating unit 16 may reset the set movement amount determining threshold and movement acceleration determining threshold in a case where the obstacle presence or absence estimating unit 16 determines that the preceding vehicle is about to enter a surrounding facility.

In the first embodiment described above, in the lighting control process, when the lighting control unit 17 performs irradiation control on the light sources 4111-1 to 4111-n and 4211-1 to 4211-n, it is assumed to turn on the light sources 4111-1 to 4111-n and 4211-1 to 4211-n with a maximum light amount of the light sources 4111-1 to 4111-n and 4211-1 to 4211-n, but this is merely an example. In the lighting control process, the lighting control unit 17 can control how much light amount the light sources 4111-1 to 4111-n and 4211-1 to 4211-n are turned on.

For example, in a case where the obstacle presence or absence estimating unit 16 estimates that an obstacle is present in the traveling lane by the fact that the movement amount of the preceding vehicle is more than the movement amount determining threshold, the lighting control unit 17 may adjust the amount of light with which the front irradiation light source is caused to irradiate the front region depending on a difference between the movement amount and the movement amount determining threshold. Specifically, the lighting control unit 17 may cause the front irradiation light source to increase the light amount with which the front region is irradiated as the difference between the movement amount and the movement amount determining threshold is larger.

As a result, the lighting control device 1 can perform control to irradiate the deemed region with light while considering glare given to the preceding vehicle. For example, it is assumed that as the preceding vehicle avoids an obstacle more largely, in other words, as a difference between the movement amount and the movement amount determining threshold is larger, a possibility that the preceding vehicle and the obstacle are present in the same divided region of the high beam irradiation possible region is lower. It is assumed that as the possibility that the preceding vehicle and the obstacle are present in the same divided region of the high beam irradiation possible region is lower, an influence of glare on the preceding vehicle due to the irradiation to the front region decreases.

In addition, in the first embodiment described above, in a case where the obstacle presence or absence estimating unit 16 estimates that an obstacle is present in the traveling lane by the fact that the movement acceleration of the preceding vehicle is more than the movement acceleration determining threshold, the lighting control unit 17 may increase a rate of change in light amount when the front irradiation light source is caused to irradiate the front region with a high beam as the difference between the movement acceleration and the movement acceleration determining threshold is larger.

As a result, the lighting control device 1 can perform control to irradiate the deemed region with light while considering glare given to the preceding vehicle. For example, it is assumed that as the preceding vehicle avoids an obstacle more quickly, in other words, as a difference between the movement acceleration and the movement acceleration determining threshold is larger, a possibility that the preceding vehicle and the obstacle are quickly turned into a state where the preceding vehicle and the obstacle are not present in the same divided region of the high beam irradiation possible region is higher. When the preceding vehicle and the obstacle are quickly turned into a state where the preceding vehicle and the obstacle are not present in the same divided region of the high beam irradiation possible region, it is assumed that an influence of glare on the preceding vehicle decreases even when a speed is increased until the front region is irradiated.

In addition, it is also assumed that the fact that the preceding vehicle has quickly avoided the obstacle means that it is necessary to quickly take an avoidance action with respect to the obstacle. By increasing the speed until the front region is irradiated, the lighting control device 1 can cause an occupant of the vehicle to visually recognize the obstacle early and to take a measure for avoiding the obstacle early.

In addition, in the first embodiment described above, the lighting control performed by the lighting control device 1 is assumed to be control to cause the plurality of light sources 4111-1 to 4111-n and 4211-1 to 4211-n constituting the high beam units 411 and 421 to emit or block a high beam. However, this is merely an example. In the lighting control, the lighting control device 1 may control the plurality of light sources 4111-1 to 4111-n and 4211-1 to 4211-n in such a manner as to emit, block, or attenuate a high beam.

For example, in the lighting control device 1, when the preceding vehicle presence or absence determining unit 14 determines that a preceding vehicle is present, the lighting control unit 17 may control any of the light sources 4111-1 to 4111-n and 4211-1 to 4211-n whose target region is a region where the preceding vehicle is present in such a manner as to attenuate light to the target region.

In addition, in the first embodiment described above, in the lighting control device 1, in a case where it is estimated that an obstacle is present in the traveling lane, the lighting control unit 17 controls the front irradiation light source in such a manner as to turn on light with a maximum light amount even when the preceding vehicle is present in the deemed region, that is, the front region. However, this is merely an example. For example, in the first embodiment described above, in a case where it is estimated that an obstacle is present in the traveling lane, the lighting control unit 17 may cause the front irradiation light source whose target region is the front region to adjust a light amount when irradiating the front region with a high beam depending on a ratio of the preceding vehicle to the front region. For example, the lighting control unit 17 causes the front irradiation light source to decrease the light amount as the ratio of the preceding vehicle to the front region increases. That is, for example, the lighting control unit 17 causes the front irradiation light source to attenuate light as the ratio of the preceding vehicle to the front region increases. As a result, the lighting control device 1 can perform control to irradiate the deemed region with light while considering glare given to the preceding vehicle.

In addition, in the first embodiment described above, in the lighting control device 1, in a case where the movement amount of the preceding vehicle is more than the movement amount determining threshold or in a case where the movement acceleration is more than the movement acceleration determining threshold, the obstacle presence or absence estimating unit 16 estimates that an obstacle is present in the traveling lane. However, this is merely an example. For example, in a case where the movement amount of the preceding vehicle is more than the movement amount determining threshold and the movement acceleration of the preceding vehicle is more than the movement acceleration determining threshold, the obstacle presence or absence estimating unit 16 may estimate that an obstacle is present in the traveling lane.

In addition, the obstacle presence or absence estimating unit 16 may estimate whether or not an obstacle is present in the traveling lane by only determining whether or not the movement amount is more than the movement amount determining threshold or only determining whether or not the movement acceleration is more than the movement acceleration determining threshold. In a case where the obstacle presence or absence estimating unit 16 only determines whether or not the movement amount is more than the movement amount determining threshold, the preceding vehicle information detecting unit 15 does not need to detect the movement acceleration of the preceding vehicle. In addition, in the operation of the lighting control device 1, step ST14 in FIG. 5, step ST114 in FIG. 7, and step ST1116 in FIG. 8 can be omitted. In a case where the obstacle presence or absence estimating unit 16 only determines whether or not the movement acceleration is more than the movement acceleration determining threshold, the preceding vehicle information detecting unit 15 does not need to detect the movement amount of the preceding vehicle. In addition, in the operation of the lighting control device 1, step ST13 in FIG. 5, step ST113 in FIG. 7, and step ST1115 in FIG. 8 can be omitted.

In addition, in the first embodiment described above, the preceding vehicle presence or absence determining unit 14 uses the lane information when determining whether or not a preceding vehicle is present. However, the preceding vehicle presence or absence determining unit 14 does not necessarily need the lane information when determining whether or not a preceding vehicle is present. The preceding vehicle presence or absence determining unit 14 may determine whether or not a preceding vehicle is present only from the ahead image. In this case, the lighting control device 1 can be configured not to include the traveling-related information acquiring unit 11 and the lane information generating unit 12. In addition, in the operation of the lighting control device 1 described with reference to the flowchart of FIG. 4, the processes of steps ST1 and ST2 can be omitted.

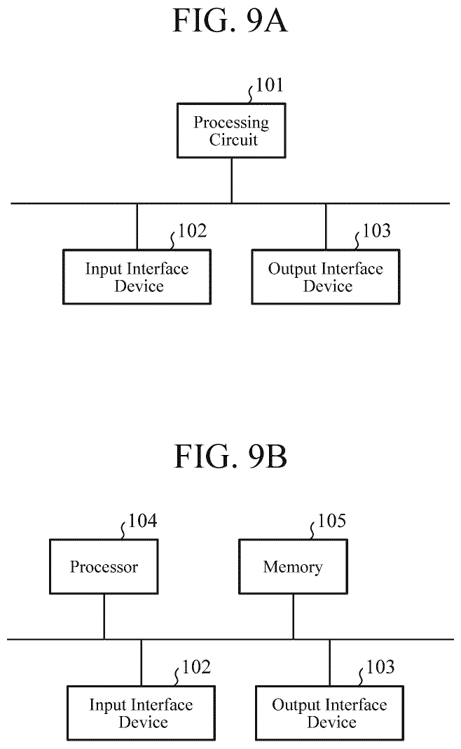

FIGS. 9A and 9B are each a diagram illustrating an example of a hardware configuration of the lighting control device 1 according to the first embodiment.

In the first embodiment, functions of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 are implemented by a processing circuit 101. That is, the lighting control device 1 includes the processing circuit 101 for estimating, in a case where a preceding vehicle is present in a lane in which the vehicle is traveling, whether or not an obstacle is present in the lane on the basis of a movement amount or a movement acceleration by which the preceding vehicle has moved, and performing lighting control based on an estimation result of whether or not the obstacle is present.

The processing circuit 101 may be dedicated hardware as illustrated in FIG. 9A, or a processor 104 that executes a program stored in a memory as illustrated in FIG. 9B.

In a case where the processing circuit 101 is dedicated hardware, for example, a single circuit, a composite circuit, a programmed processor, a parallel programmed processor, an application specific integrated circuit (ASIC), a field-programmable gate array (FPGA), or a combination thereof corresponds to the processing circuit 101.

In a case where the processing circuit is the processor 104, the functions of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 are implemented by software, firmware, or a combination of software and firmware. Software or firmware is described as a program and stored in a memory 105. The processor 104 executes the functions of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 by reading and executing the program stored in the memory 105. That is, the lighting control device 1 includes the memory 105 for storing a program that causes steps ST1 to ST7 illustrated in FIG. 4 described above to be executed as a result when the program is executed by the processor 104. In addition, it can also be said that the program stored in the memory 105 causes a computer to execute procedures or methods of processes performed by the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17. Here, for example, a nonvolatile or volatile semiconductor memory such as RAM, read only memory (ROM), flash memory, erasable programmable read only memory (EPROM), or electrically erasable programmable read-only memory (EEPROM), a magnetic disk, a flexible disk, an optical disc, a compact disc, a mini disc, a digital versatile disc (DVD), or the like corresponds to the memory 105.

Note that some of the functions of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 may be implemented by dedicated hardware, and some of the functions may be implemented by software or firmware. For example, the functions of the traveling-related information acquiring unit 11 and the captured image acquiring unit 13 can be implemented by the processing circuit 101 as dedicated hardware, and the functions of the lane information generating unit 12, the preceding vehicle presence or absence determining unit 14, the preceding vehicle information detecting unit 15, the obstacle presence or absence estimating unit 16, and the lighting control unit 17 can be implemented by the processor 104 reading and executing a program stored in the memory 105.

In addition, the lighting control device 1 includes an input interface device 102 and an output interface device 103 for performing wired communication or wireless communication with a device such as the traveling-related information acquiring device 2, the vehicle exterior camera 3, or the headlight 4.

The storage unit (not illustrated) is constituted by the memory 105 or the like.

In the first embodiment described above, the lighting control device 1 is an in-vehicle device mounted on a vehicle, and the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 are included in the in-vehicle device. Alternatively, some of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 may be included in an in-vehicle device of the vehicle, and the others may be included in a server connected to the in-vehicle device via a network. In addition, all of the traveling-related information acquiring unit 11, the lane information generating unit 12, the captured image acquiring unit 13, the preceding vehicle presence or absence determining unit 14, the preceding vehicle information detecting unit 15, the obstacle presence or absence estimating unit 16, and the lighting control unit 17 may be included in the server.

As described above, the lighting control device 1 according to the first embodiment includes: the captured image acquiring unit 13 that acquires a captured image that captures an image ahead of a vehicle; the preceding vehicle presence or absence determining unit 14 that determines, on the basis of the captured image acquired by the captured image acquiring unit 13, whether or not a preceding vehicle traveling ahead of the vehicle is present in a traveling lane in which the vehicle is traveling; the preceding vehicle information detecting unit 15 that detects information regarding movement of the preceding vehicle in a case where the preceding vehicle presence or absence determining unit 14 determines that the preceding vehicle is present; the obstacle presence or absence estimating unit 16 that estimates, on the basis of the information regarding movement of the preceding vehicle detected by the preceding vehicle information detecting unit 15, whether or not an obstacle is present in the traveling lane; and the lighting control unit 17 that controls, when the preceding vehicle presence or absence determining unit 14 determines that the preceding vehicle is present, among the plurality of light sources 4111-1 to 4111-n and 4211-1 to 4211-n that constitutes the high beam units 411 and 421, which is arranged in an array and irradiates a target region in a plurality of divided regions ahead of the vehicle with light, any of the light sources 4111-1 to 4111-n and 4211-1 to 4211-n whose target region is a region where the preceding vehicle is present in such a manner as to block or attenuate light to the target region, and controls, in a case where the obstacle presence or absence estimating unit 16 estimates that an obstacle is present in the traveling lane, any of the light sources 4111-1 to 4111-n and 4211-1 to 4211-n whose target region is a region (deemed region) where the obstacle is estimated to be present among the plurality of light sources 4111-1 to 4111-n and 4211-1 to 4211-n in such a manner as to irradiate the target region with light even when the preceding vehicle is present in the target region. Therefore, the lighting control device 1 can irradiate a region where an obstacle is estimated to be present with light in a case where the lighting control device 1 performs control to block or attenuate light to a region where a preceding vehicle is present.

Note that any component in the embodiment can be modified, or any component in the embodiment can be omitted.

### INDUSTRIAL APPLICABILITY

The lighting control device according to the present disclosure can irradiate a region where an obstacle is estimated to be present with light in a case where the lighting control device performs control to block or attenuate light to a region where a preceding vehicle is present.

### REFERENCE SIGNS LIST

1: lighting control device, 11: traveling-related information acquiring unit, 12: lane information generating unit, 13: captured image acquiring unit, 14: preceding vehicle presence or absence determining unit, 15: preceding vehicle information detecting unit, 16: obstacle presence or absence estimating unit, 17: lighting control unit, 2: traveling-related information acquiring device, 3: vehicle exterior camera, 4: headlight, 41: right light, 411, 421: high beam unit, 4111-1 to 4111-n, 4121-1 to 4121-n, 4211-1 to 4211-n, 4221-1 to 4221-n: light source, 412, 422: low beam unit, 101: processing circuit, 102: input interface device, 103: output interface device, 104: processor, 105: memory

1. A lighting control device comprising:
processing circuitry configured to
acquire a captured image that captures an image ahead of a vehicle;
determine, on a basis of the captured image having been acquired, whether or not a preceding vehicle traveling ahead of the vehicle is present in a traveling lane in which the vehicle is traveling;
detect information regarding movement of the preceding vehicle in a case where it is determined that the preceding vehicle is present;
estimate, on a basis of the detected information regarding movement of the preceding vehicle, whether or not an obstacle is present in the traveling lane; and
control, when it is determined that the preceding vehicle is present, a light source whose target region is a region where the preceding vehicle is present among a plurality of light sources arranged in an array that constitutes a high beam device and irradiates a target region in a plurality of divided regions ahead of the vehicle with light in such a manner as to block or attenuate light to the target region, and to control, in a case where the processing circuitry estimates that the obstacle is present in the traveling lane, the light source whose target region is a region where the obstacle is estimated to be present among the plurality of light sources in such a manner as to irradiate the target region with the light even when the preceding vehicle is present in the target region.

2. The lighting control device according to claim 1, wherein
the information regarding movement of the preceding vehicle is a movement amount by which the preceding vehicle has moved in a lateral direction with respect to a straight traveling direction of the preceding vehicle, or a movement acceleration by which the preceding vehicle has moved in the lateral direction with respect to the straight traveling direction of the preceding vehicle.

3. The lighting control device according to claim 1,
wherein the processing circuitry is further configured to
acquire traveling-related information related to traveling of the vehicle;
generate lane information regarding the traveling lane on a basis of the traveling-related information acquired; and
determine whether or not the preceding vehicle is present on a basis of the lane information having been generated and the captured image having been acquired.

4. The lighting control device according to claim 2, wherein
the processing circuitry estimates whether or not the obstacle is present in the traveling lane by comparing the movement amount with a movement amount determining threshold or comparing the movement acceleration with a movement acceleration determining threshold.

5. The lighting control device according to claim 4, wherein
in a case where the movement amount is more than the movement amount determining threshold or in a case where the movement acceleration is more than the movement acceleration determining threshold, the processing circuitry estimates that the obstacle is present in the traveling lane.

6. The lighting control device according to claim 5, wherein
in a case where the processing circuitry estimates that the obstacle is present in the traveling lane by the fact that the movement amount is more than the movement amount determining threshold, the processing circuitry causes the light source to increase a light amount with which the target region is irradiated as a difference between the movement amount and the movement amount determining threshold is larger.

7. The lighting control device according to claim 5, wherein
in a case where the processing circuitry estimates that the obstacle is present in the traveling lane by the fact that the movement acceleration is more than the movement acceleration determining threshold, the processing circuitry causes the light source to increase a rate of change in light amount when the target region is irradiated with the light as a difference between the movement acceleration and the movement acceleration determining threshold is larger.

8. The lighting control device according to claim 4, wherein
the processing circuitry sets the movement amount determining threshold or the movement acceleration determining threshold depending on a speed of the vehicle or a distance from the vehicle to the preceding vehicle, and performs the comparison using the set movement amount determining threshold or the set movement acceleration determining threshold.

9. The lighting control device according to claim 4, wherein
the processing circuitry determines whether or not the preceding vehicle is about to enter a surrounding facility on a basis of host vehicle information of the vehicle, map information, or the captured image, and in a case where it is determined that the preceding vehicle is about to enter the surrounding facility, the processing circuitry changes the movement amount determining threshold to be larger, and performs the comparison using the changed movement amount determining threshold.

10. The lighting control device according to claim 1, wherein
in a case where the processing circuitry estimates that the obstacle is present in the traveling lane, the processing circuitry controls, among the plurality of light sources, the light source whose target region is a region other than a region where the obstacle is estimated to be present and a region where the preceding vehicle is present in such a manner as to block or attenuate light to the target region.

11. The lighting control device according to claim 1, wherein
in a case where the processing circuitry estimates that the obstacle is present in the traveling lane, the processing circuitry causes the light source whose target region is a region where the obstacle is estimated to be present to adjust a light amount at the time of irradiation with the light depending on a ratio of the preceding vehicle to the region where the obstacle is estimated to be present.

12. A lighting control method comprising:
acquiring a captured image that captures an image ahead of a vehicle;
determining on a basis of the captured image having been acquired whether or not a preceding vehicle traveling ahead of the vehicle is present in a traveling lane in which the vehicle is traveling;
detecting information regarding movement of the preceding vehicle in a case where it is determined that the preceding vehicle is present;
estimating on a basis of the detected information regarding movement of the preceding vehicle, whether or not an obstacle is present in the traveling lane;
controlling when it is determined that the preceding vehicle is present, a light source whose target region is a region where the preceding vehicle is present among a plurality of light sources arranged in an array that constitutes a high beam device and irradiates a target region in a plurality of divided regions ahead of the vehicle with light in such a manner as to block or attenuate light to the target region; and
controlling, in a case where it is estimated that the obstacle is present in the traveling lane, the light source whose target region is a region where the obstacle is estimated to be present among the plurality of light sources in such a manner as to irradiate the target region with the light even when the preceding vehicle is present in the target region.
